(19) United States
(12) Patent Application Publication
(10) Pub. No.: US 2009/0061383 A1
(43) Pub. Date: Mar. 5, 2009

(54) Dental clinical instrument

(75) Inventor: Tae Hyun Kang, Seoul (KR)

Correspondence Address: BIRCH STEWART KOLASCH & BIRCH, PO BOX 747, FALLS CHURCH, VA, 22040-0747, US

(73) Assignee: Tae Hyun KANG & In Joon CHOI

(21) Appl. No.: 12/230,230

(22) Filed: Aug. 26, 2008

(30) Foreign Application Priority Data
Aug. 27, 2007 (KR) 10-2007-0085954

(51) Int. Cl. A61C 19/04

(52) U.S. Cl. 433/72

(57) ABSTRACT

Disclosed is a dental clinical instrument for the diagnosis of periodontal disease. The dental clinical instrument comprises a main body held by hand to apply a force during diagnosis, a probe having a front portion bent downward to be inserted into a periodontal site to be diagnosed and a rear portion coupled to the main body to allow the front portion to be movable up and down, and a measurement indicator positioned toward the probe on the main body to display a change in the location of the probe so that a user can discern the force applied to the probe wherein the measurement indicator displays the force applied to the probe when the probe elastically moves up and down with respect to the main body in a state where the probe is positioned at the periodontal site. The measurement indicator is disposed at a front end portion of the main body. Due to this constitution, the user can easily discern the force applied to the probe upon diagnosis of periodontal disease and a diagnostic error arising from a difference in the force of users can be significantly reduced.

### FIELD OF THE INVENTION

The present invention relates to a dental clinical instrument for the diagnosis of periodontal disease, and more specifically to a dental clinical instrument comprising a main body, a probe and a measurement indicator wherein the measurement indicator displays a force applied to the probe when the probe elastically moves up and down with respect to the main body in a state where the probe is positioned at a site to be diagnosed.

### BACKGROUND OF THE INVENTION

Periodontal disease is a disease that progresses slowly over a long period of time without showing any symptoms and is not treated until the patient unexpectedly has suffered serious unrecoverable damage. Further, periodontal disease is a more frequent cause of tooth loss than tooth decay in people in their forties or older. Periodontal disease is a disease that is caused by inflammation of tooth-supporting tissues rather than directly damages teeth. Periodontal disease is medically referred to as ‘periodontitis’, which is called ‘pungchi’ in Korean.

The most important thing in diagnosing periodontal disease is to measure the depth of a periodontal pocket using a dental clinical instrument. The periodontal pocket indicates the presence of an abnormally deepened gingival sulcus. For reference, a clinically normal gingival sulcus is in the form of a 0.5-2.0 mm deep groove between a tooth and the surrounding gingival tissue.

When it is intended to insert a dental clinical instrument into a space between a tooth and the gum to measure the depth of a periodontal pocket, measurement errors are caused by various factors, including the thickness and angle of the clinical instrument and the shape of a tooth flank. Therefore, it is necessary to select a suitable clinical instrument or carefully perform a medical examination in order to reduce measurement errors to predetermined limits. However, a conventional clinical instrument suffers from the problem that an error is inevitably caused by a difference in the force of users when the clinical instrument is inserted into a space between a tooth and the gum or by different inflammatory states of the periodontal tissue.

Therefore, there is a strong need to develop a dental clinical instrument that can fundamentally solve the problems of the prior art.

### SUMMARY OF THE INVENTION

The present invention has been made to solve the aforementioned problems and other technical problems that have remained unsolved in the prior art.

The present inventors have conducted intensive research and various experiments to solve the prior art problems. As a result, the present inventors have found that when a measurement indicator capable of displaying a force applied to a probe was disposed at a front end portion of a main body, which is held by hand to apply the force to the probe, to manufacture a dental clinical instrument for the diagnosis of periodontal disease, the force applied to the probe was easily discernable upon diagnosis of periodontal disease and an error arising from a difference in the force of users can be significantly reduced. The present invention has been achieved based on these findings.

In accordance with an aspect of the present invention, there is provided a dental clinical instrument for the diagnosis of periodontal disease, comprising (a) a main body held by hand to apply a force during diagnosis, (b) a probe having a front portion bent downward to be inserted into a periodontal site to be diagnosed and a rear portion coupled to the main body to allow the front portion to be movable up and down, and (c) a measurement indicator positioned toward the probe on the main body to display a change in the location of the probe so that a user can discern the force applied to the probe wherein the measurement indicator displays the force applied to the probe when the probe elastically moves up and down with respect to the main body in a state where the probe is positioned at the periodontal site.

The dental clinical instrument of the present invention allows the user to readily discern the force applied to the probe through the measurement indicator positioned at a front end portion of the main body when the user holds the main body to apply a force to insert the probe in a state where the probe is positioned in a space between a tooth and the gum of a patient. Therefore, the use of the dental clinical instrument according to the present invention can reduce an error arising from a difference in the force of users while significantly improving the diagnosis accuracy of periodontal disease.

Long-term practice and advanced skill are needed to apply a constant force to a conventional dental clinical instrument for diagnosing periodontal disease. In contrast, the dental clinical instrument of the present invention allows an unskilled user to easily adjust the force applied to the probe without any particular skill while observing the measurement indicator.

In a preferred embodiment, the dental clinical instrument of the present invention may further comprise a pincer-shaped diagnostic member mounted to a tail end of the main body. The diagnostic member may have various shapes according to the intended applications. For example, the diagnostic member is split to become narrower from a central portion toward a slightly upwardly bent distal end thereof and become wider at the distal end.

The diagnostic member can be used to check the mobility of a tooth. For example, an anterior tooth is inserted between the pincers of the diagnostic member and is then swung to check its mobility. Also, the slightly upwardly bent distal end of the diagnostic member is positioned on the occlusal surface of a posterior tooth, and then the posterior tooth is swung to check the mobility of the posterior tooth.

The mounting mode of the diagnostic member to the tail end of the main body is not specifically limited so long as the diagnostic member is mechanically coupled to the tail end. For example, the tail end of the main body may have a threaded outer surface and the diagnostic member may have a corresponding threaded inner surface so that they can be easily coupled to each other.

There is no particular limitation on the kind of a material for the probe so long as the material does not chemically react with a periodontal site to be diagnosed while maintaining a predetermined strength. For example, the probe can be made of a plastic or metal containing about 5-45% of a filler selected from talc, mica and glass fiber.

If needed, irregularities may be formed on a portion of the outer surface of the main body so that the main body can be prevented from slipping when the user holds it by hand. The probe has a diameter of about 0.5 mm or less sufficient to be easily inserted into the space between a tooth and the gum.

The measurement indicator has a recess formed inwardly from the front end portion of the main body to allow the user to discern a change in the location of the probe, so that the user can easily discern the insertion depth of the probe into the site to be diagnosed. Further, the front end portion of the main body may be recessed to form a curved portion in order to secure a sufficient field of view for the user to discern the location of the probe inserted into the site to be diagnosed.

More specifically, the front portion of the probe may include a first probe portion positioned at the site to be diagnosed and a second probe portion connected to the first probe portion. The first probe portion is disposed at a predetermined angle with respect to the second probe portion. For example, an angle between the first and second probe portions may be in the range of 60° to 90°, and an angle between the second probe portion and the rear portion may be in the range of 130° to 160°. With this angular configuration, the first probe portion can be easily inserted into the site to be diagnosed.

Further, the first probe portion has scales marked in increments to show the depth of the periodontal site or scales of different colors to allow the user to easily discern the state of the periodontal disease.

In other words, the first probe portion is formed with a plurality of scales at predetermined intervals along the outer surface from the distal end thereof. For example, the scales may be formed at intervals of 3.5 mm, 5.5 mm, 8.5 mm and 11.5 mm from the distal end of the first probe portion. In the case where the first probe portion is positioned at the periodontal site to be diagnosed and is then inserted at a force of 25 gf, the state of a periodontal pocket can be diagnosed based on the following criteria: ‘normal’ or ‘shallow’ when the insertion depth is 3.5 mm or less; ‘moderate’ when the insertion depth is from 3.5 to 5.5 mm; ‘deep’ when the insertion depth is 5.5 mm or more.

In an alternative embodiment, the first probe portion may be formed with ten scales at 1 mm intervals along the outer surface from the distal end thereof to allow the user to more accurately discern the insertion depth of the first probe portion into the site to be diagnosed by visual observation.

Further, the first probe portion may be marked with scales of different colors to allow the user to easily discern the state of the periodontal disease. For example, white and black colors can be alternately repeated for the respective scales so that the user can more easily discern the scales by visual observation.

The dental clinical instrument of the present invention can be used to accurately diagnose periodontal disease. Further, the dental clinical instrument of the present invention is light in weight and simple in structure. That is, the dental clinical instrument of the present invention can be manufactured at reduced costs and provides convenience in use.

In accordance with another aspect of the present invention, there is provided a dental clinical instrument, comprising (a) an elastically bent main body held by hand to apply a force during diagnosis, (b) a probe having a front portion bent downward to be inserted into a periodontal site to be diagnosed and a rear portion connected to a tail end of the main body to allow the front portion to be movable up and down, and (c) a measurement indicator positioned toward the probe on the main body to display a change in the location of the probe so that a user can discern the force applied to the probe wherein the measurement indicator displays the force applied to the probe when the probe elastically moves up and down with respect to the main body in a state where the probe is positioned at the periodontal site.

The dental clinical instrument is configured such that the probe is integrally connected to the main body. With this configuration, the dental clinical instrument can be manufactured in a simple manner at considerably reduced costs. Further, the dental clinical instrument is light in weight, which allows for a user to conveniently use it.

In a preferred embodiment, the dental clinical instrument may be configured such that a single linear member is elastically bent to form the main body, the probe and the measurement indicator. The measurement indicator extends in such a manner as to protrude upward from a front end portion of the main body, thus simplifying the entire structure of the dental clinical instrument.

Namely, a single linear member is used to integrally connect the main body, the probe and the measurement indicator. The use of the single linear member enables the manufacture of the dental clinical instrument in a simple manner.

In another embodiment, the dental clinical instrument may be configured such that a single linear member is elastically bent to form the main body and the probe, a handle surrounds and is coupled to a lower unit of the main body to allow an upper unit of the bent main body to be freely movable, and the measurement indicator is formed on the outer surface of a front end portion of the handle.

That is, the dental clinical instrument may have a structure in which the probe and the main body formed using a single linear member are connected to each other, the handle surrounds a lower unit of the main body, and the measurement indicator is formed on the outer surface of a front end portion of the handle. Due to this structure, a user can easily discern the insertion depth of the probe through the measurement indicator.

In another embodiment, the dental clinical instrument may be configured such that a single linear member is elastically bent to form the main body, the probe and the measurement indicator, and the measurement indicator is formed in the shape of a ring at a front end portion of the main body to allow an upper unit of the bent main body to be freely movable.

That is, the measurement indicator is provided in the form of a ring at a front end portion of the main body so that the probe can move between upper and lower limits of the ring when a force is applied to the main body.

In another modified embodiment, the dental clinical instrument may have a structure in which a single linear member is elastically bent to form the main body and the probe, a handle surrounds and is coupled to a lower unit of the main body to allow an upper unit of the bent main body to be freely movable, and the measurement indicator is formed on a front end portion of the handle.

In accordance with yet another aspect of the present invention, there is provided a method for the diagnosis of periodontal disease using the dental clinical instrument, the method comprising (a) applying a force to the main body of the dental clinical instrument to insert the front portion of the probe into a periodontal site to be diagnosed, (b) reading a scale of the measurement indicator displaying the location of the front portion in the periodontal site, (c) removing the front portion from the space between the tooth and the gum, and (d) repeating the steps (a) to (c) one or more times.

Specifically, according to the method of the present invention, periodontal disease can be diagnosed by sequentially carrying out the steps: positioning the probe in a space between a tooth and the gum of a patient; inserting the probe into a periodontal site to be diagnosed as deep as possible while applying a force of 25 gf to the main body; reading a scale of the measurement indicator displaying the location of the probe by visual observation; removing the front portion from the space between the tooth and the gum and recording the insertion depth of the probe on a chart; and repeating the steps (a) to (d) with regard to a periodontal site of another tooth to be diagnosed.

For reference, the insertion pressure of 25 gf means a force when mild anemia is observed in a finger in a state where the probe is placed under the fingernail of the finger.

### BRIEF DESCRIPTION OF THE DRAWINGS

The above and other objects, features and advantages of the present invention will become apparent from the following description of exemplary embodiments given in conjunction with the accompanying drawings, in which:

FIG. 1 is a see-through perspective view of a dental clinical instrument according to an embodiment of the present invention;

FIG. 2 is an enlarged view schematically illustrating a probe of the dental clinical instrument of FIG. 1;

FIG. 3 is a front view of the dental clinical instrument of FIG. 1;

FIG. 4 is a plan view of the dental clinical instrument of FIG. 1;

FIG. 5 is a schematic front view of the dental clinical instrument of FIG. 1, which further comprises a diagnostic member mounted at a tail end thereof;

FIG. 6 is a schematic plan view of FIG. 5; and

FIGS. 7 through 10 are schematic plan views of dental clinical instruments according to other embodiments of the present invention.

### DETAILED DESCRIPTION OF PREFERRED EMBODIMENTS

Hereinafter, exemplary embodiments of the present invention will be described with reference to the accompanying drawings, which are given only for a better understanding of the invention and do not limit the scope of the invention.

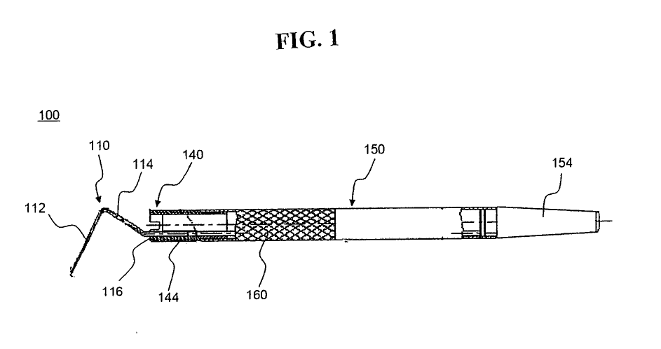

FIG. 1 is a see-through perspective view of a dental clinical instrument 100 according to an embodiment of the present invention.

Referring to FIG. 1, the dental clinical instrument 100 comprises a main body 150 held by hand to apply a force upon diagnosis of periodontal disease, a probe 110 positioned at a site to be diagnosed, and a measurement indicator 140 disposed at a front end portion of the main body 150 to display a change in the location of the probe 110 when the probe 110 is inserted into the site.

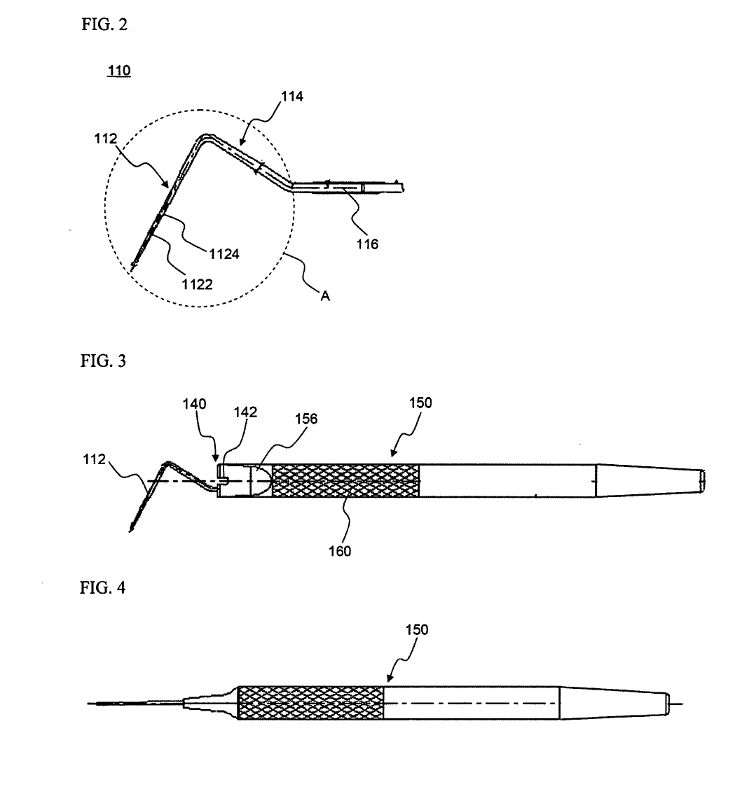

As shown in FIG. 2, the probe 110 is divided into a front portion A and a rear portion 116. The front portion A has a first probe portion 112 with a length of 21 mm and inserted into a site of periodontal disease to be diagnosed, and a second probe portion 114 with a length of 14.2 mm and bent at an angle of 84° with respect to the first probe portion 112. The second probe portion 114 is disposed at an angle of 147° with respect to the rear portion 116, so that the first probe portion 112 can be easily inserted into the site of periodontal disease.

The measurement indicator 140 includes a guide 144 surrounding the outer surface of the front end portion of the main body 150 to allow the rear portion 116 to move up and down in conjunction with the insertion depth of the first probe portion 112.

The main body 150 includes the front end portion in which the rear portion 116 of the probe 110 is mounted, a handle 160 whose surface is uneven to prevent the main body 150 from slipping when being held by a user, and a tail end to which a hollow steel bar 154 is coupled to make the dental clinical instrument light in weight.

FIG. 2 is an enlarged view schematically illustrating the probe in the dental clinical instrument of FIG. 1.

Referring to FIG. 2, ten scales 1122 and 1124 are carved at 1 mm intervals along the outer surface of the first probe portion 112 so that the user can easily discern the insertion depth of the first probe portion 112 into the site of periodontal disease by visual observation. Other configurations of the first probe portion 112 are the same as described above.

FIGS. 3 and 4 are front and plan views of the dental clinical instrument of FIG. 1, respectively.

As shown in FIGS. 3 and 4, an angled [symbol] -shaped recess 142 is indented at a predetermined depth in a front end portion of the main body 150 toward the center of the main body 150, and an elliptically curved portion 156 is tapered upward on the outer surface of the main body 150 in a direction from the front end portion toward the handle 160. With this configuration, the user can easily discern the insertion depth of the first probe portion 112 into the periodontal site through the measurement indicator 140.

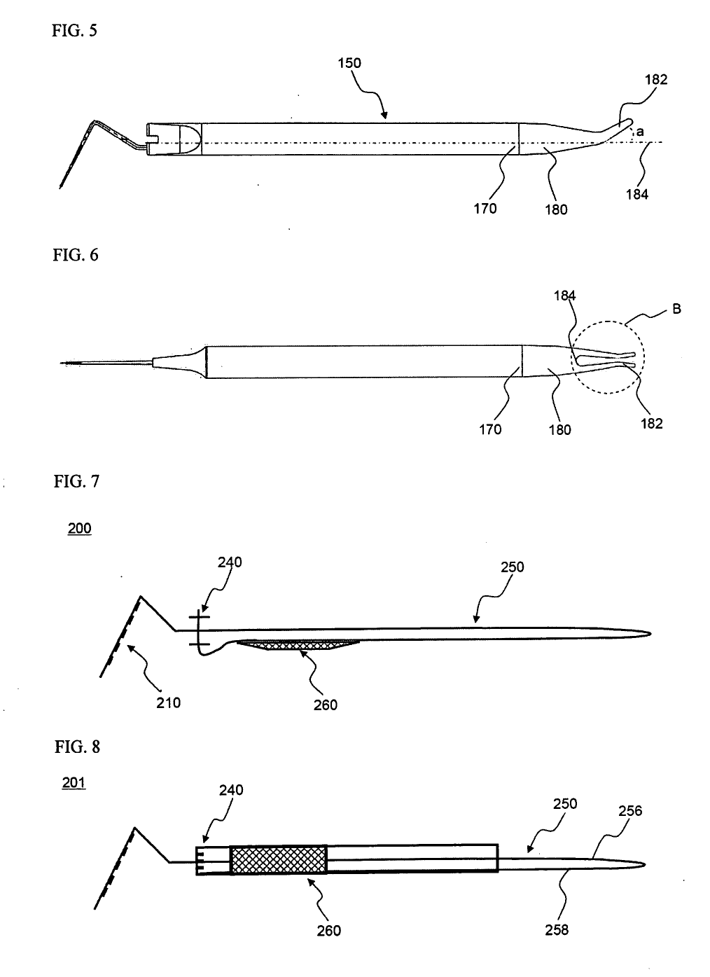

FIG. 5 is a schematic front view of the dental clinical instrument of FIG. 1, which further comprises a diagnostic member 180 mounted at a tail end 170 thereof, and FIG. 6 is a schematic plan view of FIG. 5.

Referring to FIGS. 5 and 6, the diagnostic member 180 has a pincer shape in horizontal cross section that is split to become narrower from a central portion 184 toward a distal end 182 and to become wider at the distal end 182. Further, the distal end 182 of the diagnostic member 180 is slightly bent upward at an angle “a” with respect to a virtual center line of the main body 150. With this configuration, the diagnostic member 180 becomes elastic when the dental clinical instrument pushes down a tooth (not shown), etc.

Further, an anterior tooth (not shown) is inserted between the pincers B of the diagnostic member 180 of FIG. 6 and is then swung in forward and backward directions to check its mobility. Also, the distal end 182 of FIG. 5 is positioned on the occlusal surface of a posterior tooth (not shown), and then the posterior tooth is swung in forward and backward directions under an applied force to check the mobility of the posterior tooth.

FIGS. 7 through 10 are schematic plan views of dental clinical instruments 200, 201, 202 and 203 according to other embodiments of the present invention, respectively.

Referring to FIG. 7, the dental clinical instrument 200 comprises a main body 250, a handle 260 held by hand to apply a force, a probe 210 inserted into a periodontal site to be diagnosed, a main body 250 positioned at a tail end of the probe 210, and a measurement indicator 240 protruding upward from a front end portion of the main body 250 to display the force applied to the probe 210 wherein a single linear member is used to integrally connect the main body 250, the probe 210 and the measurement indicator 240.

Referring to FIG. 8, the dental clinical instrument 201 has the same constitution as that shown in FIG. 1 except that a handle 260 surrounds and is coupled to a lower unit 258 of a main body 250 to allow an upper unit 256 of the main body 250 to be movable up and down within a measurement indicator 240, and that the measurement indicator 240 is formed on the outer surface of a front end portion of the handle 260.

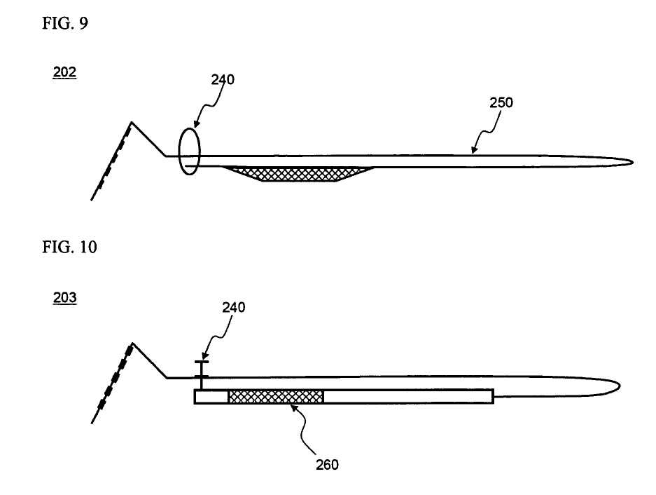

Referring to FIG. 9, the dental clinical instrument 202 has the same constitution as that shown in FIG. 1 except that a ring-shaped measurement indicator 240 is formed at a front end portion of a main body 250. The dental clinical instrument 203 is a modified embodiment of FIG. 7. Referring to FIG. 10, the dental clinical instrument 203 has the same constitution as that shown in FIG. 7 except that a measurement indicator 240 is formed on a front end portion of a handle, and thus detailed description thereof is omitted.

As apparent from the above description, the dental clinical instrument of the present invention comprises a main body held by hand to apply a force, a probe and a measurement indicator disposed at a front end portion of the main body to display the force applied to the probe. Due to this constitution of the dental clinical instrument, a user can easily discern the force applied to the probe upon diagnosis of periodontal disease. In addition, a diagnostic error arising from a difference in the force of users can be significantly reduced.

Those skilled in the art will appreciate that many modifications and variations of the present invention are possible in light of the above teachings, without departing from the scope of the invention.

1. A dental clinical instrument for the diagnosis of periodontal disease, comprising
(a) a main body held by hand to apply a force during diagnosis,
(b) a probe having a front portion bent downward to be inserted into a periodontal site to be diagnosed and a rear portion coupled to the main body to allow the front portion to be movable up and down, and
(c) a measurement indicator positioned toward the probe on the main body to display a change in the location of the probe so that the force applied to the probe is discernable,
wherein the measurement indicator displays the force applied to the probe when the probe elastically moves up and down with respect to the main body in a state where the probe is positioned at the periodontal site.

2. The dental clinical instrument according to claim 1, further comprising a pincer-shaped diagnostic member mounted to a tail end of the main body.

3. The dental clinical instrument according to claim 2, wherein the diagnostic member is split to become narrower from a central portion toward a slightly upwardly bent distal end thereof and become wider at the distal end.

4. The dental clinical instrument according to claim 1, wherein the measurement indicator has a recess formed inwardly from the front end portion of the main body so that a change in the location of the probe is discernable.

5. The dental clinical instrument according to claim 1, wherein the front portion of the probe has a first probe portion positioned at the site to be diagnosed and a second probe portion connected to the first probe portion to form a predetermined angle with respect to the first probe portion.

6. The dental clinical instrument according to claim 5, wherein the first probe portion has scales marked in increments to show the depth of the periodontal site or scales of different colors to easily discern the state of the periodontal disease.

7. A dental clinical instrument comprising, comprising
(a) an elastically bent main body held by hand to apply a force during diagnosis,
(b) a probe having a front portion bent downward to be inserted into a periodontal site to be diagnosed and a rear portion connected to a tail end of the main body to allow the front portion to be movable up and down, and
(c) a measurement indicator positioned toward the probe on the main body to display a change in the location of the probe so that the force applied to the probe is discernable,
wherein the measurement indicator displays the force applied to the probe when the probe elastically moves up and down with respect to the main body in a state where the probe is positioned at the periodontal site.

8. The dental clinical instrument according to claim 7, wherein the main body, the probe and the measurement indicator are formed by elastically bending a single linear member and the measurement indicator extends in such a manner as to protrude upward from a front end portion of the main body.

9. The dental clinical instrument according to claim 7, wherein the main body and the probe are formed by elastically bending a single linear member, a handle surrounds and is coupled to a lower unit of the main body to allow an upper unit of the bent main body to be freely movable, and the measurement indicator is formed on the outer surface of a front end portion of the handle.

10. The dental clinical instrument according to claim 7, wherein the main body, the probe and the measurement indicator are formed by elastically bending a single linear member, and the measurement indicator is formed in the shape of a ring at a front end portion of the main body to allow an upper unit of the bent main body to be freely movable.

11. The dental clinical instrument according to claim 7, wherein the main body and the probe are formed by elastically bending a single linear member, a handle surrounds and is coupled to a lower unit of the main body to allow an upper unit of the bent main body to be freely movable, and the measurement indicator is formed on a front end portion of the handle.

12. A method for the diagnosis of periodontal disease using the dental clinical instrument according to claim 1, the method comprising
(a) applying a force to the main body of the dental clinical instrument to insert the front portion of the probe into a periodontal site to be diagnosed,
(b) reading a scale of the measurement indicator displaying the location of the front portion in the periodontal site,
(c) removing the front portion from the space between the tooth and the gum, and
(d) repeating the steps (a) to (c) one or more times.

13. A method for the diagnosis of periodontal disease using the dental clinical instrument according to claim 7, the method comprising
(a) applying a force to the main body of the dental clinical instrument to insert the front portion of the probe into a periodontal site to be diagnosed,
(b) reading a scale of the measurement indicator displaying the location of the front portion in the periodontal site,
(c) removing the front portion from the space between the tooth and the gum, and
(d) repeating the steps (a) to (c) one or more times.
